(19) United States
(12) Patent Application Publication
(10) Pub. No.: US 2022/0368494 A1
(43) Pub. Date: Nov. 17, 2022

(54) UPLINK RE-TRANSMISSION WITH COMPACT MEMORY USAGE

(71) Applicant: ZEKU, INC., Palo Alto, CA (US)

(72) Inventors: Su-Lin LOW, San Diego, CA (US); Tianan MA, Palo Alto, CA (US); XiaoFei SONG, San Diego, CA (US); Hong Kui YANG, San Diego, CA (US); Hausting HONG, San Diego, CA (US)

(21) Appl. No.: 17/878,240

(22) Filed: Aug. 1, 2022

Related U.S. Application Data
(63) Continuation of application No. PCT/US2020/065762, filed on Dec. 17, 2020.
(60) Provisional application No. 62/969,864, filed on Feb. 4, 2020.

(51) Int. Cl. H04L 5/00; H04W 72/04; H04L 1/00

(52) U.S. Cl. CPC H04L 5/0048; H04W 72/0413; H04L 1/0057

(57) ABSTRACT

Embodiments of apparatuses and methods for uplink data transmission preparation are disclosed. In an example, a method for packet preparation can include creating, in a medium access control circuit, a packet list corresponding to a packet data unit for transmission. The method can also include providing the packet data unit to a physical layer circuit. The method can further include receiving, at the medium access control circuit from the physical layer circuit, information indicative of relationships between a plurality of code block groups and the packet data unit. The method can additionally include storing an association between the packet list and the plurality of code block groups based on the received information.

### CROSS-REFERENCE TO RELATED APPLICATIONS

This application is a continuation of International Application No. PCT/US2020/065762, filed on Dec. 17, 2020, which claims the benefit of priority to U.S. Provisional Application No. 62/969,864, filed on Feb. 4, 2020, the contents of which are hereby incorporated by reference in their entireties.

### BACKGROUND

Embodiments of the present disclosure relate to apparatuses and methods that may be used to prepare data for transmission in uplink.

Wireless communication systems are widely deployed to provide various telecommunication services such as telephony, video, data, messaging, and broadcasts. Various wireless communication systems rely on uplink communication of data. For example, in a fifth-generation (5G) communication system, an access node may schedule uplink transmission by one or more user equipment devices. The user equipment devices may be responsible for communicating data in the uplink according to the schedule. When the data sent by the user equipment is not correctly received at the access node, the access node may request re-transmission from the user equipment.

### SUMMARY

Embodiments of methods and apparatuses that may be used to prepare data to be transmitted and potentially re-transmitted in uplink communication are disclosed herein.

In one example, a method for packet preparation can include creating, in a medium access control circuit, a packet list corresponding to a packet data unit for transmission. The method can also include providing the packet data unit to a physical layer circuit. The method can further include receiving, at the medium access control circuit from the physical layer circuit, information indicative of relationships between a plurality of code block groups and the packet data unit. The method can additionally include storing an association between the packet list and the plurality of code block groups based on the received information.

In another example, a method for packet preparation can include receiving, at a physical layer circuit from a medium access control circuit, a packet data unit. The method can also include performing, by the physical layer circuit, code block segmentation on the packet data unit. The method can further include providing, by the physical layer circuit to the medium access control circuit, information indicative of relationships between a plurality of code block groups and the packet data unit.

In a further example, a baseband chip can include a medium access control circuit configured to create a packet list corresponding to a packet data unit for transmission and provide the packet data unit to a physical layer circuit. The medium access control circuit can further be configured to receive, from the physical layer circuit, information indicative of relationships between a plurality of code block groups and the packet data unit. The medium access control circuit can also be configured to store an association between the packet list and the plurality of code block groups based on the received information.

In an additional example, a baseband chip for packet preparation can include a physical layer circuit configured to receive, from a medium access control circuit, a packet data unit. The physical layer circuit can be configured to perform code block segmentation on the packet data unit and to provide, to the medium access control circuit, information indicative of relationships between a plurality of code block groups and the packet data unit.

In another example, a baseband chip for packet preparation can include at least one memory including computer program code and at least one processor. The at least one memory and the computer program code can be configured to, with the at least one processor, cause the baseband chip at least to create, at a medium access control layer, a packet list corresponding to a packet data unit for transmission. The at least one memory and the computer program code can also be configured to, with the at least one processor, cause the baseband chip at least to provide the packet data unit to a physical layer. The at least one memory and the computer program code can further be configured to, with the at least one processor, cause the baseband chip at least to receive, from the physical layer, information indicative of relationships between a plurality of code block groups and the packet data unit. The at least one memory and the computer program code can additionally be configured to, with the at least one processor, cause the baseband chip at least to store an association between the packet list and the plurality of code block groups based on the received information.

In yet another example, a baseband chip for packet preparation can include at least one memory including computer program code and at least one processor. The at least one memory and the computer program code can be configured to, with the at least one processor, cause the baseband chip at least to receive, at a physical layer from a medium access control layer, a packet data unit. The at least one memory and the computer program code can also be configured to, with the at least one processor, cause the baseband chip at least to perform, at the physical layer, code block segmentation on the packet data unit. The at least one memory and the computer program code can further be configured to, with the at least one processor, cause the baseband chip at least to provide, from the physical layer to the medium access control layer, information indicative of relationships between a plurality of code block groups and the packet data unit.

### BRIEF DESCRIPTION OF THE DRAWINGS

The accompanying drawings, which are incorporated herein and form a part of the specification, illustrate embodiments of the present disclosure and, together with the description, further serve to explain the principles of the present disclosure and to enable a person skilled in the pertinent art to make and use the present disclosure.

FIG. 1 illustrates a modem data processing stack.

FIG. 2 shows a data flow of packets in uplink in a modem data processing stack, according to certain embodiments of the present disclosure.

FIG. 3 illustrate an example method for packet preparation according to certain embodiments of the present disclosure.

FIG. 4 illustrates a further example method for packet preparation according to certain embodiments of the present disclosure.

FIG. 5 illustrates an additional example method for packet preparation according to certain embodiments of the present disclosure.

FIGS. 6A, 6B, 6C, and 6D illustrate an example re-transmission scheme according to certain embodiments of the present disclosure.

FIG. 7 illustrates an example method for packet preparation according to certain embodiments.

FIG. 8 illustrates an example wireless network according to certain embodiments of the present disclosure.

FIG. 9 illustrates a block diagram of an example node according to certain embodiments of the present disclosure.

FIG. 10 illustrates a block diagram of an apparatus, according to some embodiments of the present disclosure.

FIG. 11 illustrates a detailed block diagram of an example baseband chip, according to some embodiments of the present disclosure.

Embodiments of the present disclosure will be described with reference to the accompanying drawings.

### DETAILED DESCRIPTION

Although specific configurations and arrangements are discussed, it should be understood that this is done for illustrative purposes only. A person skilled in the pertinent art will recognize that other configurations and arrangements can be used without departing from the spirit and scope of the present disclosure. It will be apparent to a person skilled in the pertinent art that the present disclosure can also be employed in a variety of other applications.

It is noted that references in the specification to “one embodiment,” “an embodiment,” “an example embodiment,” “some embodiments,” “certain embodiments,” etc., indicate that the embodiment described may include a particular feature, structure, or characteristic, but every embodiment may not necessarily include the particular feature, structure, or characteristic. Moreover, such phrases do not necessarily refer to the same embodiment. Further, when a particular feature, structure or characteristic is described in connection with an embodiment, it would be within the knowledge of a person skilled in the pertinent art to effect such feature, structure or characteristic in connection with other embodiments whether or not explicitly described.

In general, terminology may be understood at least in part from usage in context. For example, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The techniques described herein may be used for various wireless communication networks such as Long-Term Evolution (LTE) system, code division multiple access (CDMA) system, time division multiple access (TDMA) system, frequency division multiple access (FDMA) system, orthogonal frequency division multiple access (OFDMA) system, single-carrier frequency division multiple access (SC-FDMA) system, and other networks. The terms “network” and “system” are often used interchangeably. A CDMA network may implement a radio technology such as Universal Terrestrial Radio Access (UTRA), CDMA 2000, etc. UTRA includes Wideband CDMA (WCDMA) and other variants of CDMA. CDMA 2000 covers IS-2000, IS-95, and IS-856 standards. A TDMA network may implement a radio technology such as Global System for Mobile Communications (GSM). An OFDMA network may implement a radio technology such as new radio (NR) (e.g., 5G RAT), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). NR is an emerging wireless communications technology under development in conjunction with the 5G Technology Forum (5GTF). 3GPP Long Term Evolution (LTE) and LTE-Advanced (LTE-A) are releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the wireless networks and radio technologies mentioned above as well as other wireless networks and radio technologies.

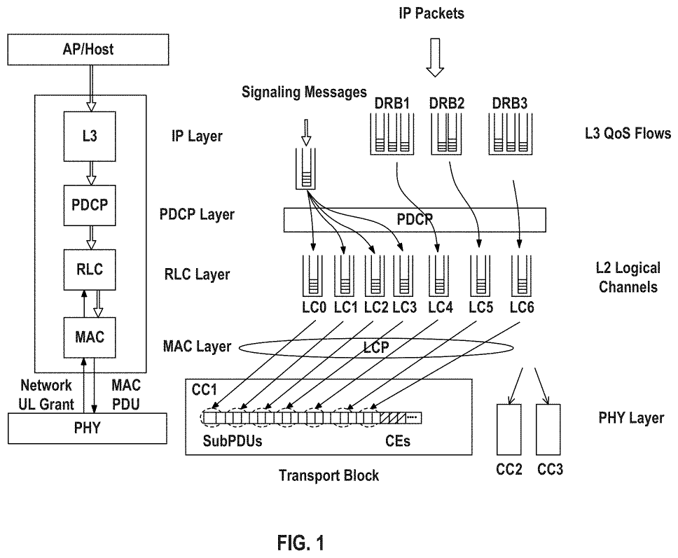

FIG. 1 illustrates a modem data processing stack. As shown in FIG. 1, in a 5G cellular wireless modem, the packet data protocol stack includes the Internet protocol (IP) layer (also known as Layer 3 (L3)), the packet data convergence protocol (PDCP) layer, the radio link control (RLC) layer, and the media access control (MAC) layer. Each layer is responsible for processing the user plane packet data in the form of IP data or raw user data and ensuring that data transmission is secure, on-time, and error-free.

In the uplink (UL) direction, incoming packet data from an external application processor (AP) or a host (e.g., through universal serial bus (USB) or peripheral component interconnected express (PCIe)) in the form of IP packets from a protocol data unit (PDU) session arrives at the Layer 3 protocol stack. These IP packets are classified into the quality of service (QoS) flows in each data radio bearer (DRB), shown as DRB1, DRB2, and DRB3. Packets in each DRB will be dequeued and processed by the packet data convergence protocol (PDCP) layer. PDCP layer processing includes robust header compression (ROHC) and security functions, such as integrity checking and ciphering. Once the PDCP layer processing is done, the packets are queued into their corresponding Layer 2 (L2) logical channels (LCs), identified as LC0, LC1, LC2, LC3, LC4, LC5, and LC6. In the meantime, modem signaling messages also arrive at their Layer 2 logical channels for signaling messages.

At the physical (PHY) layer, at every slot, the physical downlink control channel (PDCCH), which contains the downlink control indicator (DCI) information, is decoded. The DCI contains the dynamic grant allocation for dynamic uplink transmission, for a slot transmission at an indicated time.

At the MAC layer, once the dynamic grant allocation size is calculated, the modem can dequeue and gather L2 packets from the logical channels through a logical channel prioritization (LCP) algorithm as specified in the 3GPP standard and compose the MAC protocol data unit (PDU) in a transport block for the PHY layer to be sent out. There is one such transport block for each component carrier. Hence packet data is being transmitted out from the packet data stack to the base station (BS) according to the logical channel prioritization in the base station-allocated uplink grant size for each slot.

MAC sub-PDU (MacSubPDU) packets can be prepared in L2 logical channel queues after L3 data arrives at the modem. Once a dynamic grant is allocated by a base station and received by the MAC layer, the MAC layer can perform logical channel prioritization to create a MAC PDU with the exact grant size. The packets in the logical channels are extracted with priority accordingly from the logical channel prioritization. After that, the MAC PDU is transferred to the physical layer for transmission.

In another approach, logical channel L2 data within each individual logical channel queue are combined a few packets at a time to a continuous block. However, they are not prepared in a MAC PDU format because the exact grant allocation size is still not known yet. Once a dynamic grant is allocated by the base station and received by the MAC layer, the MAC layer performs the logical channel prioritization to create the MAC PDU with the exact grant size. The packets in the logical channels are extracted with priority accordingly from the logical channel prioritization. After that, the MAC PDU is transferred to the physical layer for transmission. The assembly of a first transport block corresponding to a component carrier (CC) is shown for CC1, but a similar assembly may occur for each of CC2 and CC3 and so on, as well.

Typically, the physical layer may save a copy of the entire transport block for re-transmission purposes at the PHY layer.

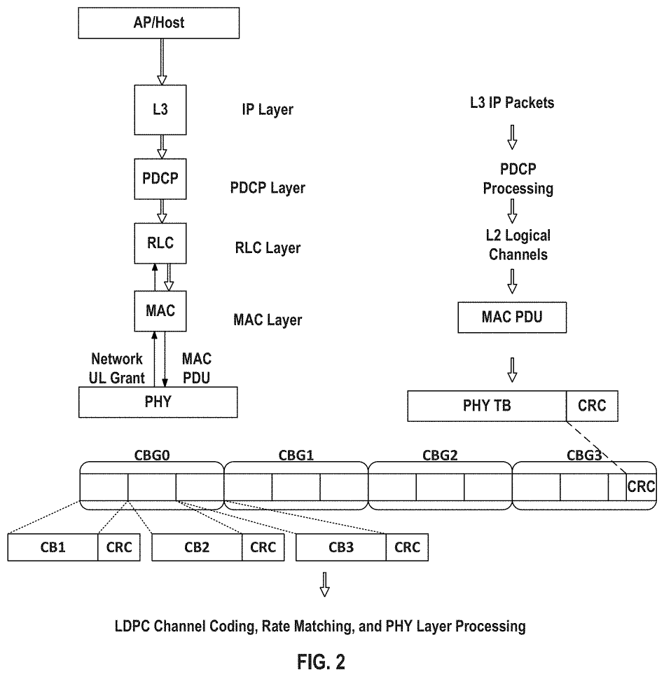

FIG. 2 shows a data flow of packets in uplink in a modem data processing stack. As shown in FIG. 2, L3 IP packets originating from an application of the user equipment may be subject to PDCP processing and may be assigned to L2 logical channels.

For example, in a 5G cellular wireless modem, the packet data protocol stack can include L3 processing, PDCP processing (which can include Robust Header Compression (ROHC), integrity checking, and ciphering), RLC layer processing, and MAC layer processing.

In a UL transmission, new packets incoming from AP/hosts may first be encoded by the data stack at the L3, PDCP, RLC, and MAC layers, and composed into a MAC PDU at the MAC layer. The MAC PDU can then be transferred to the PHY layer buffer for further processing.

Thus, at the MAC layer, a MAC PDU may be assembled. This MAC PDU may then be provided to the PHY layer, where a PHY transport block (TB) can be created, together with cyclic redundancy check (CRC) bytes for the PHY TB.

The PHY layer can also divide the TB into a plurality of code block groups (CBGs). As shown in FIG. 2, there are four CBGs, labeled CBG0 through CBG3. In this example, the TB CRC can be included in CBG3.

Moreover, each CBG may include multiple code blocks (CBs) and corresponding CB CRC. For example, the details of CBG0 are shown and include three CBs, labeled CB1, CB2, and CB3, respectively.

The assembled PHY TB, including the CBGs, can be further processed in the PHY layer, including low-density parity check (LDPC) channel coding, rate matching, and other PHY layer processing.

More particularly, at the PHY layer, the PHY TB may first be appended with a CRC, and then undergo a separate process of Code Block Segmentation to divide the whole PHY TB into multiple small CBs. Each CB may then be channel coded with Low Density Parity Check (LDPC) channel coding scheme, may undergo rate matching, and may undergo further PHY layer processing to be transmitted over the air. The PHY TB may optionally be divided into Code Block Groups (CBG), where each group includes several CBs.

Once the MAC PDU is composed of several distributed MacSubPDU packets in memory and then transferred into a contiguous PHY TB, the PHY TB can be stored and managed in a HARQ buffer in either local or external memory, for up to 16 instances per MAC instance. The PHY CB and CBG information may also be stored in memory instead of the PHY TB.

Thus, a large amount of memory may be needed for HARQ re-transmission. Moreover, preparations for HARQ re-transmission may result in data movement and external memory access. Additionally, HARQ re-transmission logic may be required at the PHY layer, and there may be complex HARQ maintenance software (SW) at L1/PHY layer. Furthermore, there may be significant power usage due to large memory storage and significant data movement.

Certain embodiments of the present disclosure can efficiently store each newly transmitted PHY TB, and resend only portions of this PHY TB for specific CBG segments, with as little memory, overhead, and power as possible.

For example, certain embodiments provide a 5G UL MAC Layer method for efficient HARQ code block group re-transmission. The PHY layer CBG and CB information can be fed back into the MAC layer, which can reconstruct the CBG re-transmission data bytes from a mapping of the CBG to the MAC packet list. This approach may save memory, as well as minimizing data movements and power.

Moreover, UL HARQ re-transmissions may occur for only specific PHY CBGs instead of the entire PHY TB. In the possibly rare case when an entire PHY TB needs to be re-transmitted, the result can be achieved by re-transmitting all the PHY CBGs of that TB.

There may be at least three aspects to certain embodiments of the present disclosure relating to a system and method for efficient HARQ CBG re-transmission. The three aspects may include the way in which the MAC layer stores CBG information, the way that CBGs can be efficiently re-transmitted, and a way of eliminating unnecessary PHY buffer storage and HARQ maintenance.

For example, according to a first aspect, a MAC layer may store CBG information together with MAC PDU data. At every new MAC PDU transmission, the information from the PHY layer for the CBGs, which can include multiple CBs, can be fed into the MAC layer. With the PHY CBG and CB segment information, the MAC layer can reconstruct the CBG mapping from the MAC packet list (PktList) of data buffers, which can already be present in memory and kept for HARQ re-transmissions in addition to RLC and PDCP re-transmissions.

According to a second aspect, certain embodiments may provide efficient re-transmission of CBG with minimal data movement and power. Upon network (NW)-requested dynamic re-transmission of CBG, as indicated in a packet data control channel (PDCCH), the MAC layer can extract the CBG data bytes from its CBG mapping of stored MAC PDU packet list and can transfer the data to the PHY layer efficiently. The PHY layer can extract the CB packets and can process each CB directly without delay. The re-transmission can be done with minimal data movements and power.

According to a third aspect, certain embodiments may eliminate unnecessary PHY buffer storage and HARQ maintenance. Thus, in certain embodiments, no additional data movements, duplicate storage, or HARQ timers and maintenance logic may be required by the PHY layer to perform HARQ re-transmissions. These and other aspects, benefits, and advantages are illustrated by the following non-limiting examples.

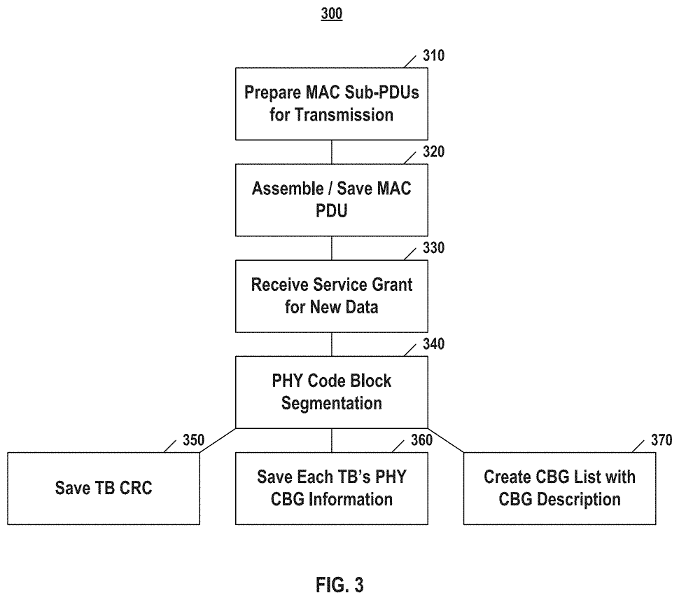

FIG. 3 illustrates an example method 300 for packet preparation according to certain embodiments of the present disclosure. Method 300 of FIG. 3 may include, at 310, preparing MAC sub-PDUs for transmission. When the MAC sub-PDUs have been prepared, at 320, method 300 can also include assembling and saving a MAC PDU. The MAC PDU may be assembled and saved prior to receiving a service grant for new data. The MAC PDU may then be modified if necessary. For example, a service grant for new data may be received at 330, and the assembled MAC PDU may be modified to align with the service grant. Alternatively, the system may wait for the service grant at 330 before assembling and saving the MAC PDU at 320.

At 340, the PHY layer circuit can perform physical layer code block segmentation. Then, at 350, the system may save the TB CRC to the medium access control layer. At 360, the system may save each TB's physical layer CBG information to the medium access control layer. The system may further create a CBG list with a CBG description at 370.

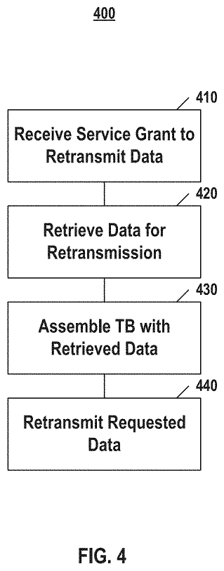

FIG. 4 illustrates a further example method 400 for packet preparation according to certain embodiments of the present disclosure. Method 400 of FIG. 4 may include, at 410, receiving a service grant to re-transmit data. The service grant may include an indicator of a specific code block group or a specific code block for which transmission is desired.

At 420, hardware may retrieve the data for transmission using the information regarding the mapping between the MAC PDU and CBGs. At 430, the PHY layer can assemble a TB for transmission including the data retrieved at 420. In certain embodiments, the MAC layer may be responsible for retrieving the data, while the PHY layer may be responsible for placing the retrieved data in a transport block. At 440, the requested data can be re-transmitted by the physical layer.

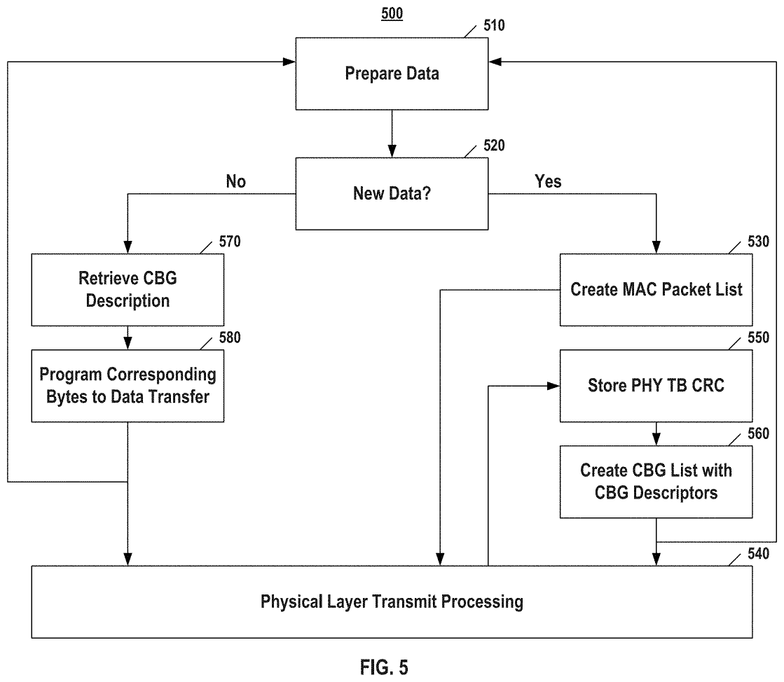

FIG. 5 illustrates an additional example method 500 for packet preparation according to certain embodiments of the present disclosure. Method 500 can include, at 510, preparing data to be transmitted. The method can start with a user equipment in radio resource control (RRC) connected and a data transfer state. If physical downlink control channel (PDDCH) and downlink control information (DCI) are decoded, and an uplink grant is received, then at 520, the system may determine whether the data to be transmitted is new data. If so, at 530, the MAC layer may create a MAC packet list. MAC can copy the packet descriptors for all packets that are composed into a given MAC PDU for the NW grant size, to an allocated continuous sending MacPktList. This can be used for fast hardware reading and data transfer to PHY efficiently. MAC can save this MACPktList to a MACHarqQ Table that is maintained for up to 16 entries per MAC instance.

Physical layer transmit processing can occur at 540. Then, at 550, the MAC layer can store the PHY TB CRC, and at 560, the MAC layer can create a CBG list with CBG descriptors. PHY can run CBG segmentation, can calculate the total number of CBs, and the CB size of each CB segment, and can store the following information to MAC: PHY TB CRC data bytes which are written to the tail of the MAC PDU; the number of CBG=min (total number of CBs, Max CBG configured); and list of CB sizes=[CB1_len, CB2_len, CB3_len, . . . ]. Further physical layer transmit processing can then proceed at 540.

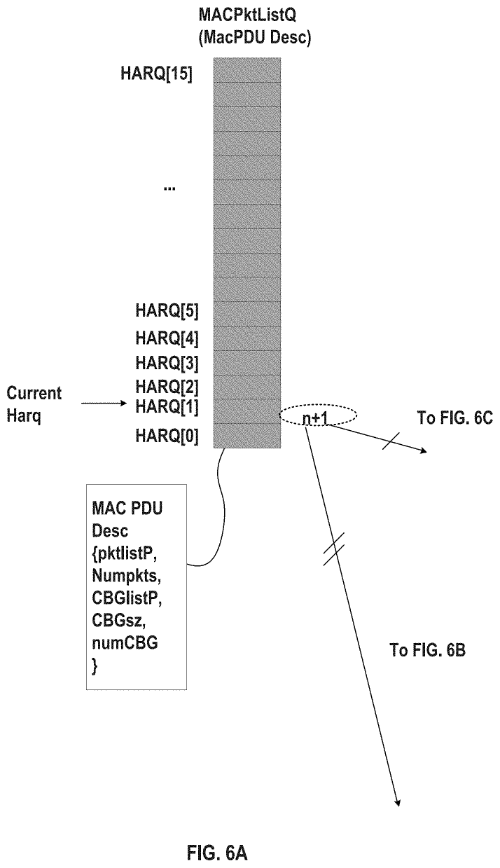

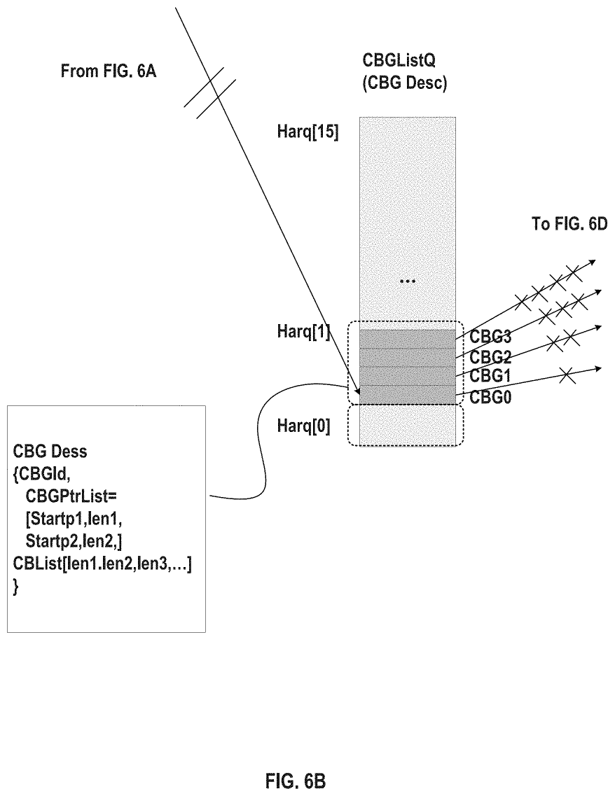

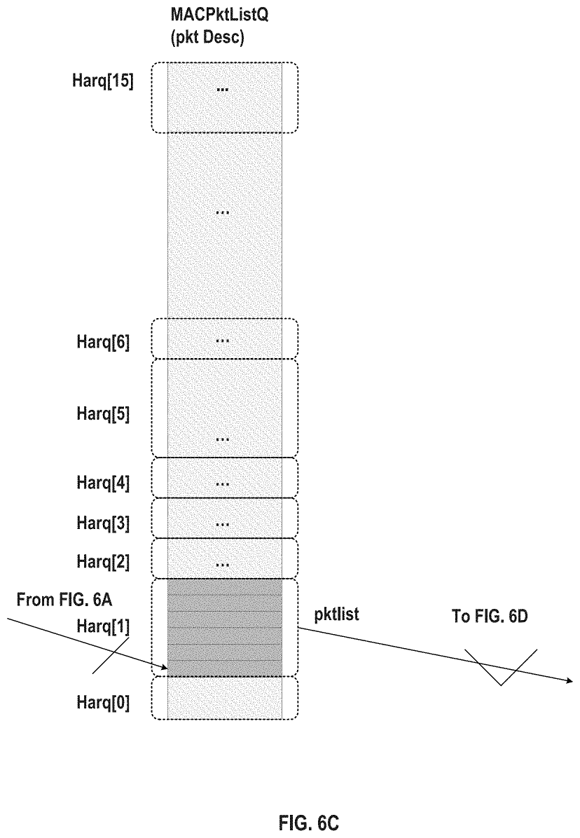

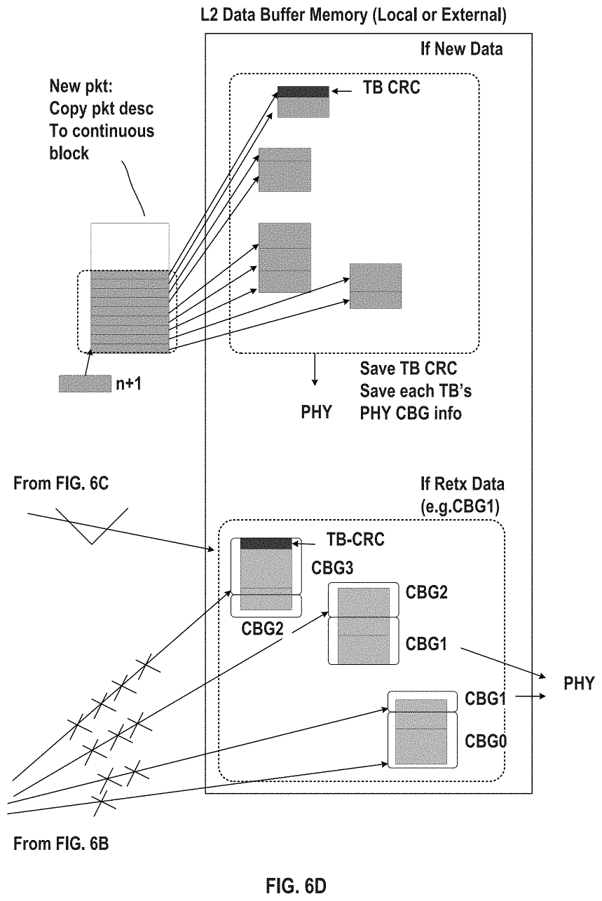

As mentioned above, at 560, the MAC layer can create a CBG list with CBG descriptors. The MAC can review the current MAC PDU MacPktList, which includes packet data buffers in distributed memory, and can create a CBGList with CBG descriptor for each CBG, including the information pertaining to each CBG: CBG start pointer list, namely a list of start addresses for each CBG section belonging to this CBG; a CBGPtrList namely [Startp1, Len1; Startp2, Len2; . . . ]; CB Len List, namely a list of CB length (len) for each CB segment, in this CBG; and CBList[len1, Len2, len3, . . . ], as shown in FIG. 6B, for example.

For example, at 520, once an NW Grant is allocated to the UE, the MAC layer can first determine whether the NW requests a re-transmission for a specific HARQId MAC PDU that was transmitted earlier, or a new MAC PDU, by decoding the DCI's new data indication (NDI) information from the PDCCH.

Where a new data TB is requested, the MAC can prepare the MAC PDU for the new data at 510. A new data MAC PDU can be composed of several packet data buffers which may be distributed in different memory locations, to fulfill the allocated grant size from the NW. These data packets can then be transferred to the PHY buffer, where the PHY layer can attach a CRC and can then perform further code block segmentation into smaller code blocks for faster and manageable encoding and decoding. Each small CB can then be processed with channel coding, rate matching, and further PHY layer processing at 540.

At 510, the L2 data may undergo PDCP processing, which can include robust header compression (ROHC), integrity checking, and ciphering. The data buffers may be in distributed locations, but can be as continuous as possible in the memory pool area.

The information from the PHY layer for the code block group, which can include multiple CBs, can be fed into the MAC layer at 550. The CBG grouping of multiple CBs can enable the HARQ acknowledgements to be performed at the CBG group level for efficiency instead of individual CBs.

The MAC layer can, at 560, reconstruct the CBG mapping from the MAC PktList, and stores the CBG mapping structure in the MAC layer, together with the data buffers that needed to be kept for subsequent HARQ re-transmission. No additional data movements, storage or HARQ timers, and maintenance logic are required by PHY layer.

If the data that is being prepared via 510 is determined at 520 to be a re-transmission, then at 570, the system can retrieve a CBG description corresponding to data that has been requested for transmission. Then, at 580, the system can program the corresponding bytes for data transfer to the physical layer. Then, at 540, the system can proceed with physical layer transmit processing.

Upon HARQ re-transmission requests by the NW for a particular HARQId, for specific CBG data, the CBG data bytes can easily be retrieved at 570 using a CBGlist mapping, where the pointer location for the distributed packet data bytes can then be transferred to the PHY layer quickly. Thus, for example, the MAC can retrieve the CBG descriptor information for a specific requested CBG(k) by indexing into MACHarqQ for the HARQId entry. In this HARQId entry, the CBG descriptor for this CBG(k) can be retrieved by indexing into the CBGList array.

At 580, the PHY can extract the CB size and boundary information from MAC, as well as the raw CB data bytes, from the CBG transferred into the PHY buffer and then can perform further PHY layer processing on each CB efficiently without delay at 540. For example, the MAC can extract the CBG data bytes through the CBG descriptor pointers to the CBG start address and lengths, which may span across multiple blocks. The CBG data bytes can be transferred to PHY, which may also extract the CB data blocks from the stored CBG descriptor CBlist info.

FIGS. 6A, 6B, 6C, and 6D illustrate an example re-transmission scheme according to certain embodiments of the present disclosure. As shown in FIG. 6A, a MAC PDU packet list queue (MACPktListQ) can be populated with MAC PDU descriptors (Desc). Each entry in the MAC packet list can correspond to a different HARQ entry. In this case, there are up to 16 entries, labeled HARQ[0] through HARQ[15]. A current HARQ may be HARQ[1].

Each MAC PDU descriptor may include packet list P (pcktlistP), number of packets (Numpkts), CBG list P (CBGlistP), CBG size (CBGsz), and number of CBGs (numCBG).

FIG. 6B shows a CBG list queue (CBGListQ), which may include entries for each of the HARQ entries shown in FIG. 6A. The CBG list queue may be populated with CBG descriptors, which can include CBG identifier (CBGId), CBG pointer list (CBGPtrList), and CB list. The CBG part list can include an identifier of the start (Startp1, Startp2, and so on) and an identifier of the length of the corresponding CBG (len1, len2, and so on). The CB list can include the length of each code block.

FIG. 6C shows additional details of the MAC packet list queue. As shown in FIG. 6C, each HARQ entry may be of its own unique length, with a plurality of entries. These entries may correspond to one or a plurality of code blocks.

FIG. 6D shows an L2 data buffer memory, according to certain embodiments of the present disclosure. As shown at the top of FIG. 6D, if there is a new packet, a packet descriptor can be copied to a continuous block including, among other things, a TB CRC. The data can be prepared for upcoming transmission, having already been PDCP processed. Each TB CRC can be saved, as can each TB's PHY CBG information.

As shown at the bottom of FIG. 6D, if there is re-transmission of data, a particular CBG or group of CBGs can be passed to the PHY layer. The CBG can be identified using a CBG descriptor, which can be provided when the data is originally stored.

Through this scheme, the retransmission (Retx) CBG data can be encoded and transmitted quickly with minimal data movement, and no storage of HARQ data, HARQ timers, and maintenance logic are required by PHY layer.

Certain embodiments may have various benefits and/or advantages. For example, certain embodiments may provide a practical scheme with minimal complexity. Moreover, certain embodiments may provide minimal data movements from MAC to PHY layer for dynamic re-transmissions. Additionally, certain embodiments may provide optimized external memory access for data transmissions and re-transmissions. Moreover, certain embodiments may rely on minimal data memory, storing packets at MAC layer only rather than at both MAC layer and PHY layer. Certain embodiments may eliminate PHY code block data storage and PHY HARQ maintenance functions. Additionally, certain embodiments may provide reduced latency in HARQ dynamic re-transmissions and lower power due to minimal data movement and minimal data access. Certain embodiments may be applicable for a variety of different wireless technologies requiring dynamic re-transmission of Code Block Groups or similar grouping of data blocks, such as 5G, LTE, or future 3GPP or other standards.

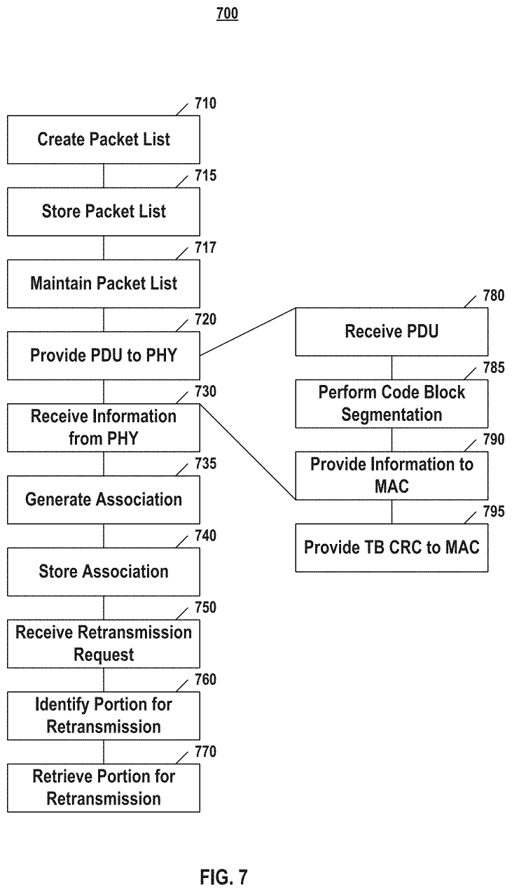

FIG. 7 illustrates an example method 700 for packet preparation according to certain embodiments. As shown in FIG. 7, method 700 for packet preparation can include, at 710, creating, in a medium access control circuit, a packet list corresponding to a packet data unit for transmission. Method 700 can also include, at 720, providing the packet data unit to a physical layer circuit. Method 700 can further include, at 730, receiving, at the medium access control circuit from the physical layer circuit, information indicative of relationships between a plurality of code block groups and the packet data unit. Method 700 can additionally include, at 740, storing an association between the packet list and the plurality of code block groups based on the received information.

The packet list can include packet descriptors for all packets that are composed into the packet data unit. Method 700 can also include, at 715, storing, by the medium access control circuit, the packet list before providing the packet data unit to the medium access control circuit.

Method 700 can further include, at 717, maintaining the packet list for multiple entries per medium access control instance.

The information received from the physical layer may include a number of configured code block groups for the packet data unit. For example, the information can include a list of code block sizes.

Method 700 may also include, at 735, generating, by the medium access control circuit, the association. Generating the association can include generating a list of starting addresses for a plurality of code block group sections. Generating the association can also or alternatively generating a list of lengths of code block segments of each code block group of the plurality of code block groups.

Method 700 can further include, at 750, receiving, at the medium access control circuit, a request to transmit at least one code block of the packet data unit. Method 700 can additionally include, at 760, identifying, by the medium access control circuit, at least one portion of the packet data unit by referring to the stored association. Method 700 can also include, at 770, retrieving, by the medium access control circuit, the at least one portion of the packet data unit.

Method 700 can further include, at 780, receiving, at the physical layer circuit from the medium access control circuit, the packet data unit. Method 700 can additionally include, at 785, performing, by the physical layer circuit, code block segmentation on the packet data unit. Method 700 can further include, at 790, providing, by the physical layer circuit to the medium access control circuit, information indicative of relationships between a plurality of code block groups and the packet data unit.

The information, as mentioned above, can include a number of configured code block groups for the packet data unit. The information can also or alternatively include a list of code block sizes.

Method 700 can also include, at 795, providing, by the physical layer circuit to the medium access control circuit, physical transport block cyclic redundancy check data bytes corresponding to the packet data unit. This information can also be stored by the MAC, as illustrated above in FIG. 6D.

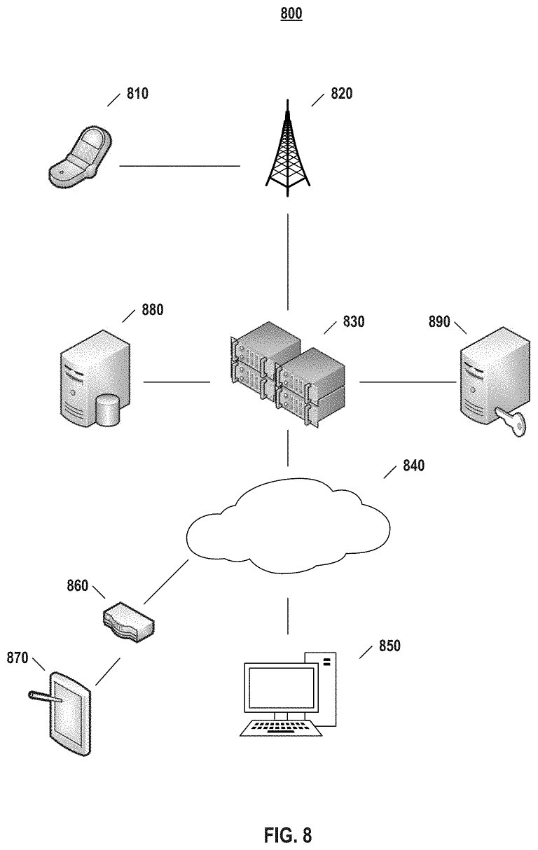

FIG. 8 illustrates an example wireless network 800, such as an NR or 5G network, in which aspects of the present disclosure may be performed, for example, for enabling uplink data preparation, as described in greater detail below. As shown in FIG. 8, wireless network 800 may include a network of nodes, such as a user equipment 810, an access node 820, and a core network element 830. User equipment 810 may be any terminal device, such as a smart phone, personal computer, laptop computer, tablet computer, vehicle computer, wearable electronic device, smart sensor, or any other device capable of receiving, processing, and transmitting information, such as any member of a vehicle to everything (V2X) network, a cluster network, a smart grid node, or an Internet-of-Things (IoT) node. Other devices are also permitted. User equipment 810 is illustrated as a smart phone simply by way of illustration and not by way of limitation.

An access node 820 may be a device that communicates with the user equipment 810, such as wireless access point, a base station, an enhanced Node B (eNB), a cluster master node, or the like. Access node 820 may have a wired connection to user equipment 810, a wireless connection to user equipment 810, or any combination thereof. Access node 820 may be connected to user equipment 810 by multiple connections, and user equipment 810 may be connected to other access nodes in addition to access node 820. Access node 820 may also be connected to other user equipment. Access node 820 is illustrated by a radio tower by way of illustration and not by way of limitation.

A core network element 830 may serve access node 820 and user equipment 810 to provide core network services. Examples of a core network element 830 include a home subscriber server (HSS), a mobility management entity (MME), a serving gateway (GW), a packet data network (PDN) GW. These are examples of core network elements of an evolved packet core (EPC) system, which is a core network for the LTE system. Other core network elements may be used in LTE and in other communication systems. Core network element 830 is shown as a set of rack-mounted servers by way of illustration and not by way of limitation.

Core network element 830 may connect with a large network, such as the Internet 840, or another IP network, to communicate packet data over any distance. In this way, data from user equipment 810 may be communicated to other user equipment connected to other access points, including, for example, a personal computer 850 connected to Internet 840, for example, using a wired connection, or a tablet 870 connected to Internet 840 via a router 860. Thus, personal computer 850 and tablet 870 provide additional examples of possible user equipment devices, and router 860 provides an example of another access point device.

A generic example of a rack-mounted server is provided as an illustration of core network element 830. However, there may be multiple elements in the core network including database servers, such as database 880, and security and authentication servers, such as authentication server 890. Database 880 may, for example, manage data related to user subscription to network services. A home location register (HLR) is an example of standardized database of subscriber information for a mobile network. Likewise, authentication server 890 may handle authentication of users, sessions, and so on. In 5G, an authentication server function (AUSF) may be the specific entity to perform user equipment authentication. In certain embodiments, a single server rack may handle multiple such functions, such that the connections between core network element 830, authentication server 890, and database 880 may be local connections within a single rack.

Certain embodiments of the present disclosure may be implemented in a modem of a user equipment, such as user equipment 810, tablet 870, or personal computer 850. For example, a modem or other transceiver of user equipment 810 may prepare packets for transmission and re-transmission to a communication from access node 820. As described above in detail, user equipment 810 may prepare packets and store them suitably at the MAC layer.

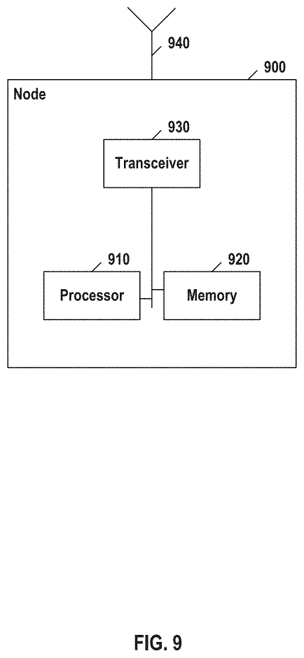

Each of the elements of FIG. 8 may be considered a node of a communication network. More detail regarding the possible implementation of communication nodes is provided by way of example in the description of FIG. 9 and node 900 below. For example, user equipment 810 in FIG. 8 may be implemented as node 900 shown in FIG. 9.

FIG. 9 illustrates a device according to certain embodiments of the present disclosure. As shown in FIG. 9, a node 900 can include various components. Node 900 can correspond to user equipment 810, access node 820, or core network element 830 in FIG. 8. In some embodiments, node 900 corresponds to the modem in user equipment 810, access node 820, or core network element 830 in FIG. 8.

As shown in FIG. 9, node 900 can include a processor 910, a memory 920, and a transceiver 930. These components are shown as connected to one another by a bus, but other connection types are also permitted. Transceiver 930 may include any suitable device for sending and/or receiving data. Node 900 may include one or many transceivers, although only one transceiver 930 is shown for simplicity of illustration. An antenna 940 is shown as a possible communication mechanism for node 900. Multiple antennas and/or arrays of antennas may be utilized. Additionally, examples of node 900 may communicate using wired techniques rather than (or in addition to) wireless techniques. For example, access node 820 may communicate wirelessly to user equipment 810 and may communicate by a wired connection (for example, by optical or coaxial cable) to core network element 830. Other communication hardware, such as a network interface card (NIC), can be included.

When node 900 is a user equipment, additional components may also be included, such as a user interface (UI), sensors, and the like. Similarly, node 900 may be implemented as a blade in a server system when node 900 is configured as a core network element 830. Other implementations are also possible.

As shown in FIG. 9, node 900 may include processor 910. Although only one processor is shown, it is understood that multiple processors can be included. Processor 910 may be any suitable computational device, such as a central processing unit (CPU), a microcontroller unit (MCU), application-specific integrated circuit (ASIC), field-programmable gate array (FPGA), or the like. Processor 910 may be a hardware device having one or many processing cores. In some embodiments in which node 900 corresponds to a modem, processor 910 may be a baseband processor.

As shown in FIG. 9, node 900 may also include memory 920. Although only memory is shown, it is understood that multiple memories can be included. Memory 920 can broadly include both memory and storage. For example, memory 920 can include random access memory (RAM) included on the same chip with processor 910. Memory 920 can also include storage, such as a hard disk drive (HDD), solid-state drive (SSD), or the like. Other memory types and storage types are also permitted.

Similarly, node 900 can also be configured as personal computer 850, router 860, tablet 870, database 880, or authentication server 890 in FIG. 8. Node 900 can be configured to perform any of the above-described methods using hardware alone or hardware operating together with software.

Another aspect of the disclosure is directed to a non-transitory computer-readable medium encoded with instructions that, when executed by at least one processor (e.g., processor 910 in FIG. 9), perform any processes disclosed herein. The computer-readable medium may include volatile or non-volatile, magnetic, semiconductor, tape, optical, removable, non-removable, or other types of computer-readable medium or computer-readable storage devices. For example, the computer-readable medium may be the storage device or the memory module having the computer instructions stored thereon, as disclosed. In some embodiments, the computer-readable medium may be a disc, a flash drive, or a solid-state drive having the computer instructions stored thereon.

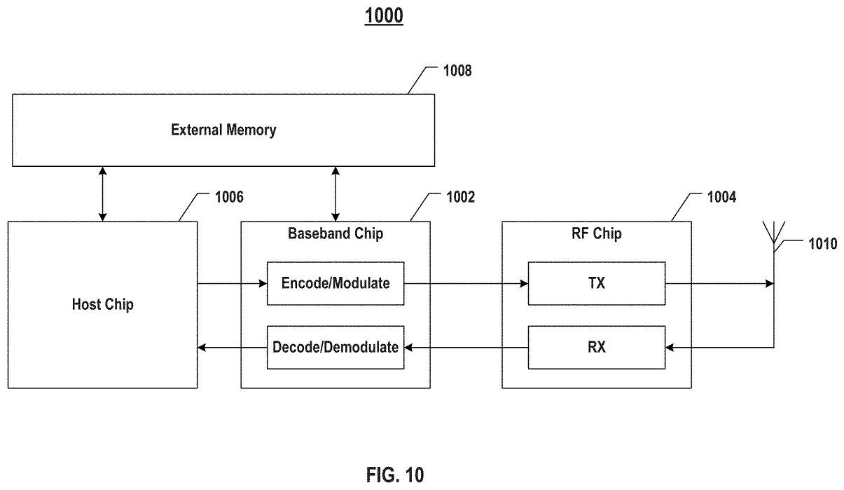

FIG. 10 illustrates a block diagram of an apparatus 1000 including a baseband chip 1002, a radio frequency chip 1004, and a host chip 1006, according to some embodiments of the present disclosure. Apparatus 1000 may be an example of any suitable node of wireless network 800 in FIG. 8, such as user equipment 810 or access node 820. As shown in FIG. 10, apparatus 1000 may include baseband chip 1002, radio frequency chip 1004, host chip 1006, and one or more antennas 1010. In some embodiments, baseband chip 1002 is implemented by processor 910 and memory 920, and radio frequency chip 1004 is implemented by processor 910, memory 920, and transceiver 930, as described above with respect to FIG. 9. Besides the on-chip memory (also known as “internal memory” or “local memory,” e.g., registers, buffers, or caches) on each chip 1002, 1004, or 1006, apparatus 1000 may further include an external memory 1008 (e.g., the system memory or main memory) that can be shared by each chip 1002, 1004, or 1006 through the system/main bus. Although baseband chip 1002 is illustrated as a standalone SoC in FIG. 10, it is understood that in one example, baseband chip 1002 and radio frequency chip 1004 may be integrated as one SoC; in another example, baseband chip 1002 and host chip 1006 may be integrated as one SoC; in still another example, baseband chip 1002, radio frequency chip 1004, and host chip 1006 may be integrated as one SoC, as described above.

In the uplink, host chip 1006 may generate raw data and send it to baseband chip 1002 for encoding, modulation, and mapping. Baseband chip 1002 may also access the raw data generated by host chip 1006 and stored in external memory 1008, for example, using the direct memory access (DMA). Baseband chip 1002 may first encode (e.g., by source coding and/or channel coding) the raw data and modulate the coded data using any suitable modulation techniques, such as multi-phase pre-shared key (MPSK) modulation or quadrature amplitude modulation (QAM). Baseband chip 1002 may perform any other functions, such as symbol or layer mapping, to convert the raw data into a signal that can be used to modulate the carrier frequency for transmission. In the uplink, baseband chip 1002 may send the modulated signal to radio frequency chip 1004. Radio frequency chip 1004, through the transmitter (Tx), may convert the modulated signal in the digital form into analog signals, i.e., radio frequency signals, and perform any suitable front-end radio frequency functions, such as filtering, up-conversion, or sample-rate conversion. Antenna 1010 (e.g., an antenna array) may transmit the radio frequency signals provided by the transmitter of radio frequency chip 1004.

In the downlink, antenna 1010 may receive radio frequency signals and pass the radio frequency signals to the receiver (Rx) of radio frequency chip 1004. Radio frequency chip 1004 may perform any suitable front-end radio frequency functions, such as filtering, down-conversion, or sample-rate conversion, and convert the radio frequency signals into low-frequency digital signals (baseband signals) that can be processed by baseband chip 1002. In the downlink, baseband chip 1002 may demodulate and decode the baseband signals to extract raw data that can be processed by host chip 1006. Baseband chip 1002 may perform additional functions, such as error checking, de-mapping, channel estimation, descrambling, etc. The raw data provided by baseband chip 1002 may be sent to host chip 1006 directly or stored in external memory 1008.

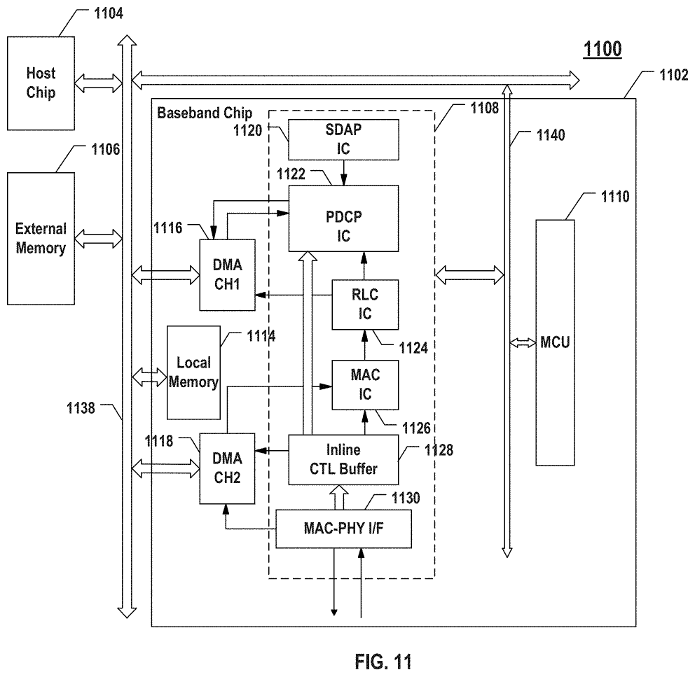

Baseband chip 1002 in FIG. 10 may correspond to baseband chip 1102 in FIG. 11. Baseband chip 1002 may implement the protocol stack shown in FIG. 1, including MAC layer, RLC layer, and PDCP layer. Similarly, host chip 1006 in FIG. 10 may correspond to host chip 1104 in FIG. 11. Likewise, external memory 1008 in FIG. 10 may correspond to external memory 1106 in FIG. 11.

FIG. 11 illustrates a detailed block diagram of an example baseband chip 1102 implementing Layer 2 downlink data processing using Layer 2 circuits 1108 and an MCU 1110, according to some embodiments of the present disclosure. In some embodiments, Layer 2 circuits 1108 include a service data adaptation protocol (SDAP) circuit 1120, a PDCP circuit 1122, an RLC circuit 1124, and a MAC circuit 1126. As explained above, PDCP circuit 1122 may correspond to PDCP layer in FIG. 1, and RLC circuit 1124 and MAC circuit 1126 may similarly correspond to RLC layer and MAC layer in FIG. 1. In some embodiments, each of SDAP, PDCP, RLC, and MAC circuits 1120, 1122, 1124, or 1126 is an integrated circuit (IC) dedicated to performing the functions of the respective layer in Layer 2 user plane. For example, each of SDAP, PDCP, RLC, and MAC circuits 1120, 1122, 1124, or 1126 may be an application-specific integrated circuit (ASIC), which is customized for a particular use, rather than intended for general-purpose use, and thus, is known for its high speed, small die size, and low power consumption compared with a generic processor. As another alternative, a general purpose processor, such as microcontroller unit (MCU) 1110, can implement the PDCP layer, RLC layer, and MAC layer, as shown in FIG. 1.

Apparatus 1100 may be any suitable node of wireless network 800 in FIG. 8, such as user equipment 810 or access node 820 (e.g., a base station including eNB in LTE or gNB in NR). As shown in FIG. 11, apparatus 1100 may include baseband chip 1102, a host chip 1104, an external memory 1106, and a main bus 1138 (also known as a “system bus”) operatively coupling baseband chip 1102, host chip 1104, and external memory 1106. That is, baseband chip 1102, host chip 1104, and external memory 1106 may exchange data through main bus 1138. The baseband chip 1102 may implement the methods shown in FIGS. 3, 4, 5, and 7 and the architecture shown in FIG. 10.

As shown in FIG. 11, baseband chip 1102 may also include a plurality of direct memory access (DMA) channels including a first DMA channel (DMA CH1) 1116 and a second DMA channel (DMA CH2) 1118. Each DMA channel 1116 or 1118 can allow certain Layer 2 circuits 1108 to access external memory 1106 directly independent of host chip 1104. In some embodiments, DMA channels 1116 and 1118 may include a DMA controller and any other suitable input/output (I/O) circuits. The plurality of direct memory access (DMA) channels may correspond to PDMA, RDMA, MDMA, and IDMA in FIG. 1. As shown in FIG. 11, baseband chip 1102 may further include a local memory 1114, such as an on-chip memory on baseband chip 1102, which is distinguished from external memory 1106 that is an off-chip memory not on baseband chip 1102. In some embodiments, local memory 1114 includes one or more L1, L2, L3, or L4 caches. Local memory may also include the re-ordering windows and TB holding buffers, as discussed above. Layer 2 circuits 1108 may access local memory 1114 through main bus 1138 as well.

As shown in FIG. 11, baseband chip 1102 may further include a local bus 1140. In some embodiments, MCU 1110 is operatively coupled to Layer 2 circuits 1108 and main bus 1138 through local bus 1140.

Referring to Layer 2 circuits 1108, Layer 2 circuits 1108 may be configured to receive Layer 1 transport blocks (as the inputs of Layer 2 circuits 1108) and generate Layer 3 data packets (as the outputs of Layer 2 circuits 1108) from the Layer 1 transport blocks in an in-line manner In some embodiments, Layer 2 circuits 1108 are configured to pass data through each layer of Layer 2 circuits 1108 without storing the data in external memory 1106. The data may flow from lower to upper layers in Layer 2 (e.g., MAC circuit 1126, RLC circuit 1124, and PDCP circuit 1122).

As shown in FIG. 11, MAC-PHY interface 1130 may be operatively coupled to in-line control buffer 1128 and configured to receive the Layer 1 transport blocks from Layer 1 (e.g., the PHY layer). The operations of MAC-PHY interface 1130 may be controlled based on a set of interface commands from MCU 1110. Each Layer 1 transport block may contain data from the previous radio subframe, having multiple or partial packets, depending on scheduling and modulation. Each Layer 1 transport block may correspond to a MAC PDU and include a payload (e.g., having encrypted data) and multiple headers (e.g., MAC header, RLC header, and PDCP header).

In some embodiments, each Layer 1 transport block is divided into a plurality of code blocks (CBs), and MAC-PHY interface 1130 receives the Layer 1 transport blocks in the unit of each code block through code block-related signals, such as CB_DATA indicative of the data values of a code block, CB_START indicative of the start of a new code block, CB_LENGTH indicative of the length of the code block, and CB_INDEX indicative of the order number of the code block in the received transport block. MAC-PHY interface 1130 may also receive status signals, for example, DATA_READY indicative of a valid cycle of received packet data and TB_ID indicative of the index of the transport block.

As shown in FIG. 11, in-line control buffer 1128 may be operatively coupled to MAC-PHY interface 1130 and configured to store the Layer 1 transport blocks received by MAC-PHY interface 1130. In-line control buffer 1128 may be a separate physical memory component or part of local memory 1114 (e.g., a logical partition thereof) dedicated to Layer 2 downlink data processing. In some embodiments, in-line control buffer 1128 is further configured to buffer the Layer 1 transport blocks to be adapted to Layer 1 data rate, for example, when the Layer 1 data rate exceeds the peak Layer 2 downlink data processing capability of baseband chip 1102. Layer 2 circuits 1108 in baseband chip 1102 may perform Layer 2 downlink data processing in an in-line manner without access to external memory 1106. In order to adapt to the higher Layer 1 data rate, in-line control buffer 1128 may perform the MAC-PHY flow control function by buffering the Layer 1 transport blocks. It is understood that in some examples, second DMA channel 1118 operatively coupled to in-line control buffer 1128 and MAC-PHY interface 1130 may be configured to transmit some of the Layer 1 transport blocks from in-line control buffer 1128 or directly through MAC-PHY interface 1130 to external memory 1106 to overflow the Layer 1 transport blocks when the capacity of in-line control buffer 1128 is overloaded, for example, by an extremely high Layer 1 data rate.

As shown in FIG. 11, MAC circuit 1126 may be operatively coupled to in-line control buffer 1128 and RLC circuit 1124 and configured to process the MAC headers of the Layer 1 transport blocks stored in in-line control buffer 1128. The processing of the MAC headers by MAC circuit 1126 may be controlled based on a set of MAC commands from MCU 1110.

In some embodiments, the functions of MAC circuit 1126 in processing the MAC headers are defined by the 3GPP standards. For example, MAC circuit 1126 may perform HARQ, MAC downlink mapping, and/or MAC format selection and measurement by processing the MAC headers of the Layer 1 transport blocks, which are extracted and read from in-line control buffer 1128. It is understood that in case any update or change being made to the required functions of the MAC Layer, MCU 1110 may reflect the update or change in its MAC commands to control MAC circuit 1126 to act accordingly.

As shown in FIG. 11, RLC circuit 1124 may be operatively coupled to MAC circuit 1126 and PDCP circuit 1122 and configured to process the RLC headers of the Layer 1 transport blocks received from MAC circuit 1126. The processing of the RLC headers may be controlled based on a set of RLC commands from MCU 1110.

Similar to MAC circuit 1126, in some embodiments, RLC circuit 1124 can be configured to process only the RLC header, but not the payload of a Layer 1 transport block stored in in-line control buffer 1128. For example, MAC circuit 1126 may extract and read the MAC and RLC headers of the Layer 1 transport block stored in in-line control buffer 1128, and RLC circuit 1124 may receive the RLC header from MAC circuit 1126. It is understood that in some examples, RLC circuit 1124 may extract and read the RLC header of the Layer 1 transport block from in-line control buffer 1128 directly. Nevertheless, RLC circuit 1124 does not read the payload of the Layer 1 transport block, and does not process other headers, such as MAC header and PDCP headers, according to some embodiments. That is, in some embodiments, none of MAC circuit 1126 and RLC circuit1124 processes the payloads of the Layer 1 transport blocks stored in in-line control buffer 1128.

As shown in FIG. 11, PDCP circuit 1122 may be operatively coupled to RLC circuit 1124 and SDAP circuit 1120 and configured to process the PDCP headers of the Layer 1 transport blocks received from RLC circuit 1124. The processing of the PDCP headers may be controlled based on a set of PDCP commands from MCU 1110.

In some embodiments, PDCP circuit 1122 is configured to process the PDCP header before reading and processing the payload of a Layer 1 transport block stored in in-line control buffer 1128. For example, MAC circuit 1126 may extract and read the MAC, RLC, and PDCP headers of the Layer 1 transport block stored in in-line control buffer 1128, RLC circuit 1124 may receive the RLC and PDCP headers from MAC circuit 1126, and PDCP circuit 1122 may receive the PDCP header from RLC circuit 1124. It is understood that in some examples, PDCP circuit 1122 may extract and read the PDCP header of the Layer 1 transport block from in-line control buffer 1128 directly.

After processing the PDCP header, PDCP circuit 1122 may be configured to process the payload of the Layer 1 transport block stored in in-line control buffer 1128. In some embodiments, the processing of the payload is based, at least in part, on the processed PDCP header of the Layer 1 transport block and thus, is performed after the processing of the PDCP header. In some embodiments, the processing of the payload is based, at least in part, on the processed RLC header and/or the processed MAC header of the Layer 1 transport block as well. It is understood that in some examples, the processing of the PDCP header and the processing of the RLC header may be performed independently and/or simultaneously. Nevertheless, PDCP circuit 1124 is the driving stage that starts to pull payloads out of in-line control buffer 1128 and is the only Layer 2 circuit 1108 that processes the payloads of the Layer 1 transport blocks, according to some embodiments. In some embodiments, PDCP circuit 1124 may be configured to generate a Layer 3 data packet based on the processed PDCP header and payloads of the Layer 1 transport block. In some embodiments, the Layer 3 data packet is generated based on the processed RLC header and/or MAC header as well.

According to one aspect of the present disclosure, a method for packet preparation can include creating, in a medium access control circuit, a packet list corresponding to a packet data unit for transmission. The method can also include providing the packet data unit to a physical layer circuit. The method can further include receiving, at the medium access control circuit from the physical layer circuit, information indicative of relationships between a plurality of code block groups and the packet data unit. The method can additionally include storing an association between the packet list and the plurality of code block groups based on the received information.

In some embodiments, the packet list comprises packet descriptors for all packets that are composed into the packet data unit.

In some embodiments, the method can further include storing, by the medium access control circuit, the packet list before providing the packet data unit to the medium access control circuit.

In some embodiments, the method can further include maintaining the packet list for multiple entries per medium access control instance.

In some embodiments, the information can include a number of configured code block groups for the packet data unit.

In some embodiments, the information can include a list of code block sizes.

In some embodiments, the method can further include generating, by the medium access control circuit, the association. Generating the association can include generating a list of starting addresses for a plurality of code block group sections.

In some embodiments, the method can further include generating, by the medium access control circuit, the association. Generating the association can include generating a list of lengths of code block segments of each code block group of the plurality of code block groups.

In some embodiments, the method can further include receiving, at the medium access control circuit, a request to transmit at least one code block of the packet data unit. The method can additionally include identifying, by the medium access control circuit, at least one portion of the packet data unit by referring to the stored association. The method can also include retrieving, by the medium access control circuit, the at least one portion of the packet data unit.

According to another aspect of the present disclosure, a method for packet preparation can include receiving, at a physical layer circuit from a medium access control circuit, a packet data unit. The method can also include performing, by the physical layer circuit, code block segmentation on the packet data unit. The method can further include providing, by the physical layer circuit to the medium access control circuit, information indicative of relationships between a plurality of code block groups and the packet data unit.

In some embodiments, the information can include a number of configured code block groups for the packet data unit.

In some embodiments, the information can include a list of code block sizes.

In some embodiments, the method can also include providing, by the physical layer circuit to the medium access control circuit, physical transport block cyclic redundancy check data bytes corresponding to the packet data unit.

According to a further aspect of the present disclosure, a baseband chip can include a medium access control circuit configured to create a packet list corresponding to a packet data unit for transmission and provide the packet data unit to a physical layer circuit. The medium access control circuit can further be configured to receive, from the physical layer circuit, information indicative of relationships between a plurality of code block groups and the packet data unit. The medium access control circuit can also be configured to store an association between the packet list and the plurality of code block groups based on the received information.

In some embodiments, the packet list can include packet descriptors for all packets that are composed into the packet data unit.

In some embodiments, the medium access control circuit can be further configured to store the packet list before providing the packet data unit to the medium access control circuit.

In some embodiments, the medium access control circuit can be further configured to maintain the packet list for multiple entries per medium access control instance.

In some embodiments, the information can include a number of configured code block groups for the packet data unit.

In some embodiments, the information can include a list of code block sizes.

In some embodiments, the medium access control circuit can be further configured to generate the association. Generating the association can include generating a list of starting addresses for a plurality of code block group sections.

In some embodiments, the medium access control circuit can be further configured to generate the association. Generating the association can include generating a list of lengths of code block segments of each code block group of the plurality of code block groups.

The medium access control circuit can be further configured to receive a request to transmit at least one code block of the packet data unit, identify at least one portion of the packet data unit by referring to the stored association, and retrieve the at least one portion of the packet data unit.

According to an additional aspect of the present disclosure, a baseband chip for packet preparation can include a physical layer circuit configured to receive, from a medium access control circuit, a packet data unit. The physical layer circuit can be configured to perform code block segmentation on the packet data unit and to provide, to the medium access control circuit, information indicative of relationships between a plurality of code block groups and the packet data unit.

In some embodiments, the information can include a number of configured code block groups for the packet data unit.

In some embodiments, the information can include a list of code block sizes.

In some embodiments, the physical layer circuit can be further configured to provide, to the medium access control circuit, physical transport block cyclic redundancy check data bytes corresponding to the packet data unit.

According to still another aspect of the present disclosure, a baseband chip for packet preparation can include at least one memory including computer program code and at least one processor. The at least one memory and the computer program code can be configured to, with the at least one processor, cause the baseband chip at least to create, at a medium access control layer, a packet list corresponding to a packet data unit for transmission. The at least one memory and the computer program code can also be configured to, with the at least one processor, cause the baseband chip at least to provide the packet data unit to a physical layer. The at least one memory and the computer program code can further be configured to, with the at least one processor, cause the baseband chip at least to receive, from the physical layer, information indicative of relationships between a plurality of code block groups and the packet data unit. The at least one memory and the computer program code can additionally be configured to, with the at least one processor, cause the baseband chip at least to store an association between the packet list and the plurality of code block groups based on the received information.

According to yet another aspect of the present disclosure, a baseband chip for packet preparation can include at least one memory including computer program code and at least one processor. The at least one memory and the computer program code can be configured to, with the at least one processor, cause the baseband chip at least to receive, at a physical layer from a medium access control layer, a packet data unit. The at least one memory and the computer program code can also be configured to, with the at least one processor, cause the baseband chip at least to perform, at the physical layer, code block segmentation on the packet data unit. The at least one memory and the computer program code can further be configured to, with the at least one processor, cause the baseband chip at least to provide, from the physical layer to the medium access control layer, information indicative of relationships between a plurality of code block groups and the packet data unit.

The foregoing description of the specific embodiments will so reveal the general nature of the present disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

Embodiments of the present disclosure have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The Summary and Abstract sections may set forth one or more but not all example embodiments of the present disclosure as contemplated by the inventor(s), and thus, are not intended to limit the present disclosure and the appended claims in any way.

Various functional blocks, modules, and steps are disclosed above. The particular arrangements provided are illustrative and without limitation. Accordingly, the functional blocks, modules, and steps may be re-ordered or combined in different ways than in the examples provided above. Likewise, certain embodiments include only a subset of the functional blocks, modules, and steps, and any such subset is permitted.

The breadth and scope of the present disclosure should not be limited by any of the above-described example embodiments, but should be defined only in accordance with the following claims and their equivalents.

What is claimed is:

1. A method for packet preparation, comprising:
creating, in a medium access control circuit, a packet list corresponding to a packet data unit for transmission;
providing the packet data unit to a physical layer circuit;
receiving, at the medium access control circuit from the physical layer circuit, information indicative of relationships between a plurality of code block groups and the packet data unit; and
storing an association between the packet list and the plurality of code block groups based on the received information.

2. The method of claim 1, wherein the packet list comprises packet descriptors for all packets that are composed into the packet data unit.

3. The method of claim 1, further comprising:
storing, by the medium access control circuit, the packet list before providing the packet data unit to the medium access control circuit.

4. The method of claim 1, further comprising:
maintaining the packet list for multiple entries per medium access control instance.

5. The method of claim 1, wherein the information comprises a number of configured code block groups for the packet data unit or a list of code block sizes.

6. The method of claim 1, further comprising:
generating, by the medium access control circuit, the association, wherein generating the association comprises generating at least one of:
a list of starting addresses for a plurality of code block group sections; or
a list of lengths of code block segments of each code block group of the plurality of code block groups.

7. The method of claim 1, further comprising:
receiving, at the medium access control circuit, a request to transmit at least one code block of the packet data unit;
identifying, by the medium access control circuit, at least one portion of the packet data unit by referring to the stored association; and
retrieving, by the medium access control circuit, the at least one portion of the packet data unit.

8. A method for packet preparation, comprising:
receiving, at a physical layer circuit from a medium access control circuit, a packet data unit;
performing, by the physical layer circuit, code block segmentation on the packet data unit; and
providing, by the physical layer circuit to the medium access control circuit, information indicative of relationships between a plurality of code block groups and the packet data unit.

9. The method of claim 8, wherein the information comprises a number of configured code block groups for the packet data unit or a list of code block sizes.

10. The method of claim 8, further comprising:
providing, by the physical layer circuit to the medium access control circuit, physical transport block cyclic redundancy check data bytes corresponding to the packet data unit.

11. A baseband chip, comprising:
a medium access control circuit configured to create a packet list corresponding to a packet data unit for transmission and provide the packet data unit to a physical layer circuit,
wherein the medium access control circuit is further configured to receive, from the physical layer circuit, information indicative of relationships between a plurality of code block groups and the packet data unit, and
wherein the medium access control circuit is further configured to store an association between the packet list and the plurality of code block groups based on the received information.

12. The baseband chip of claim 11, wherein the packet list comprises packet descriptors for all packets that are composed into the packet data unit.

13. The baseband chip of claim 11, wherein the medium access control circuit is further configured to store the packet list before providing the packet data unit to the medium access control circuit.

14. The baseband chip of claim 11, wherein the medium access control circuit is further configured to maintain the packet list for multiple entries per medium access control instance.

15. The baseband chip of claim 11, wherein the information comprises a number of configured code block groups for the packet data unit or a list of code block sizes.

16. The baseband chip of claim 11, wherein the medium access control circuit is further configured to generate the association, wherein generating the association comprises at least one of:
generating a list of starting addresses for a plurality of code block group sections; or
generating a list of lengths of code block segments of each code block group of the plurality of code block groups.

17. The baseband chip of claim 11, wherein the medium access control circuit is further configured to receive a request to transmit at least one code block of the packet data unit, identify at least one portion of the packet data unit by referring to the stored association, and retrieve the at least one portion of the packet data unit.

18. A baseband chip for packet preparation, comprising:
a physical layer circuit configured to receive, from a medium access control circuit, a packet data unit,
wherein the physical layer circuit is configured to perform code block segmentation on the packet data unit and to provide, to the medium access control circuit, information indicative of relationships between a plurality of code block groups and the packet data unit.

19. The baseband chip of claim 18, wherein the information comprises a number of configured code block groups for the packet data unit or a list of code block sizes.

20. The baseband chip of claim 18, wherein the physical layer circuit is further configured to provide, to the medium access control circuit, physical transport block cyclic redundancy check data bytes corresponding to the packet data unit.
